(19) United States
(12) Patent Application Publication
(10) Pub. No.: US 2016/0266726 A1
(43) Pub. Date: Sep. 15, 2016

(54) Display Control Method And Device

(71) Applicant: Lenovo (Beijing) Co., Ltd., Beijing (CN)

(72) Inventors: Peng ZHAN, Beijing (CN); Ziyan SUN, Beijing (CN)

(73) Assignee: LENOVO (BEIJING) CO., LTD., Beijing (CN)

(21) Appl. No.: 14/848,843

(22) Filed: Sep. 9, 2015

(30) Foreign Application Priority Data
Mar. 13, 2015 (CN) 201510112021.7

(51) Int. Cl. G06F 3/0481

(52) U.S. Cl. CPC G06F 3/0481

(57) ABSTRACT

A display method and device are provided in the disclosure. The method includes: At least one object displayed by an electronic device and first information of the object are obtained, and if it is determined that the first information meets a first predetermined condition, the display status of the object is adjusted from a first status to a second status different from the first status. The device includes: a display module, configured to display at least one object; a processor, configured to obtain the at least one object displayed by the display module, obtain first information of the object; and adjust a display status of the object from a first status to a second status, in a case that the first information meets a first predetermined condition.

### CROSS-REFERENCE TO RELATED APPLICATIONS

The present application claims priority to Chinese Patent Application No. 201510112021.7, filed with the State Intellectual Property Office of People's Republic of China on Mar. 13, 2015 entitled “DISPLAY OBJECT CONTROL METHOD AND DEVICE”, the content of which is incorporated herein by reference in its entirety.

### TECHNICAL FIELD

The disclosure relates to the field of display interface control, and in particular to a display control method and device.

### BACKGROUND

In order to meet visual needs of users and enhance user experiences, intelligent electronic devices, such as television and computer, with large display screens, lead the development of this field at present.

Nowadays, multiple types of applications are installed into an electronic device to meet the needs of users, such as video/music player, image viewer, browser, notepad, calculator, and message editor. In practice, when the user opens and operates an application, the object is displayed on the display interface of the electronic device. Thus, when the user opens multiple applications, a number of objects are displayed on the display interface of the electronic device, which results in that the user differentiates these objects difficultly, thereby reducing user experience.

### SUMMARY

In view of this, a display control method and device are provided in the disclosure.

An embodiment of the present disclosure provides A display control method, which includes: obtaining at least one object displayed by an electronic device; obtaining first information of the object; determining whether the first information meets a first predetermined condition; and adjusting a display status of the object from a first status to a second status, if it is determined that the first information meets a first predetermined condition.

An embodiment of the present disclosure provides A display control device, which includes: a display module, configured to display at least one object; a processor, configured to obtain the at least one object displayed by the display module, obtain first information of the object; and adjust a display status of the object from a first status to a second status, in a case that the first information meets a first predetermined condition.

### BRIEF DESCRIPTION OF THE DRAWINGS

To illustrate the technical solutions according to the embodiments of the disclosure more clearly, the drawings to be used in the description of the embodiments are described briefly hereinafter. Apparently, the drawings in the following description are only a part of rather than all of the embodiments of the disclosure, and other drawings may be obtained by those skilled in the art according to those drawings without creative effort.

FIG. 1 is a flowchart of a display control method according to an embodiment of the disclosure;

FIG. 2 is a flowchart of a display control method according to an embodiment of the disclosure;

FIG. 3 is a structural diagram of a display control device according to an embodiment of the disclosure;

FIG. 4 is a partial structural diagram of a display control device according to another embodiment of the disclosure;

FIG. 5 is a structural diagram of a display control device according to another embodiment of the disclosure; and

FIG. 6 is a structural diagram of a display control device according to another embodiment of the disclosure.

### DETAILED DESCRIPTION OF THE EMBODIMENTS

Hereinafter, the technical solutions according to the embodiments of the disclosure are described clearly and completely in conjunction with the drawings according to the embodiments of the disclosure. Apparently, the described embodiments are only a part of rather than all of the embodiments of the disclosure. All the other embodiments obtained by those skilled in the art based on the embodiments of the disclosure without creative effort fall within the protection scope of the disclosure.

The present disclosure provides a method display control method and device, which are applied to an electronic device. At least one object displayed by the electronic device and first information of the object are obtained; and if it is determined that the first information meets a first predetermined condition, the display status of the object is adjusted from a first status to a second status different from the first status, thus the user is allowed to intuitively differentiate, among the objects displayed by the electronic device, the object whose information meets the first predetermined condition, and the object whose information does not meet the first predetermined condition, to facilitate a subsequent operation of the user, and user experience is significantly improved.

To make the above objectives, features and merits of the disclosure more clear, the disclosure is illustrated in conjunction with drawings and specific embodiments.

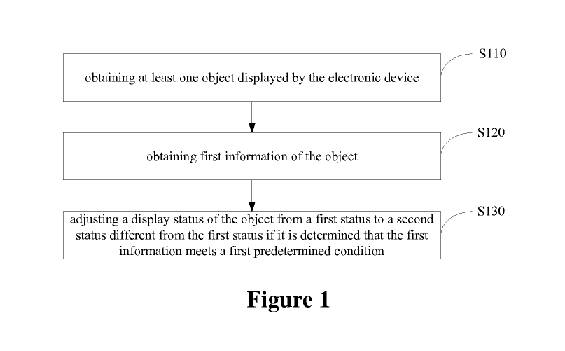

FIG. 1 is a flowchart of a display control method according to an embodiment of the disclosure. The method may be applied to an electronic device such as tablet computer and cell phone, and may include steps S110-S130.

Step S110 may include obtaining at least one object displayed by the electronic device.

The object may be an image, video or music playing window, a notepad edit window, an application icon, etc. Taking an electronic device with an Aura operating system as an example, a user may place objects such as various images, video or music playing windows and game operating windows on the display interface, which meets requirements of multiple users. For details, a conventional tablet computer with the Aura operating system may be referred to, and they are not described herein.

Step S120 may include obtaining first information of the display object.

The first information may include current display status information of the object (may include display transparency and display brightness of the object, etc.), operating status information of the object (the object is being operated, an operation on the object is accomplished or paused), and corresponding time, etc. The disclosure is not limited herein.

Step S130 may include adjusting a display status of the object from a first status to a second status different from the first status if it is determined that the first information meets a first predetermined condition.

According to the embodiment, whether the first information meets the first predetermined condition can be determined by determining whether an idle duration after an operation on the object is accomplished is greater than a first threshold. In this case, the first predetermined condition may be the first threshold, and the obtained first information is the idle duration after the operation on the object is accomplished.

It should be noted that, for the object with an edit window, the above case that the operation on the object is accomplished may be that the edit window of the object is closed; for a play window, the above case that the operation on the object is accomplished may be that video or music currently played is closed or deleted, to allow the player to stay in a status with no music or video played.

Optionally, whether the first information meets the first predetermined condition can be determined by determining whether an idle duration after an operation on the object is paused is greater than a second threshold. In this case, the first predetermined condition may be the second threshold, and the obtained first information of the object is the idle duration after the operation on the object is paused.

It should be noted that, for the object with an edit window, the above case that the operation on the object is paused may be that editing for the content is accomplished when the edit window of the object is not closed; for a play window, the above case that the operation on the object is paused may be that video or music currently played is paused. In addition, the above first threshold and the second threshold may be set based on actual demand, the first threshold and the second threshold may be the same or different, and the disclosure is not limited.

It may be learned from the above that, in practice, when an operation on the object is accomplished, and no operation on the object is detected before the idle duration reaches the first threshold; or, when an operation on the object is paused, and no operation on the object is detected before the idle duration reaches the second threshold, the system adjusts the display status of the object from the first status to the second status different from the first status. Thus a user is allowed to intuitively differentiate, among the objects displayed by the electronic device, the object whose first information meets the first predetermined condition, and the object whose first information does not meet the first predetermined condition, to facilitate a subsequent operation, and user experience is improved.

Optionally, based on the above embodiment, if it is determined that the idle duration after the operation on the object is accomplished is greater than a maximum threshold, the object may be closed or deleted automatically, which conveniently makes the display interface of electronic device concise.

In practice, display status of the object differs when an operation on the object is performing, or in an idle duration after an operation on the object is accomplished or paused reaches the first threshold, or an duration after an operation on the object is accomplished reaches a maximum threshold. Thus, through observing display status of each of objects displayed by the electronic device, the user may conveniently differentiate that, the object which is being operated, the object on which an operation is paused or accomplished for a period of time (the period of time is greater than the first threshold), and the object on which an operation is accomplished for a long time (the long time is greater than the maximum threshold), without opening the objects one by one by the user.

Specifically, in a case that the display status is changed through adjusting the display transparency of object, the display transparency in the first status and that in the second status of object in step S130 are different. Further, in a case that the object is being operated, to enhance visual perception of the user, the display transparency of the object may be set as zero, i.e., the object is in a non-transparent status; in a case that the idle duration after an operation on the object is paused or accomplished is greater than the first threshold, the display transparency of the object is increased with time, making the user observes the object more and more transparently. Thus, based on the transparency of each of the objects, the user may accurately differentiate the objects on which operations are paused or accomplished at different time.

It should be noted that, for an object on which an operation is paused, the display transparency stops change after reaching a preset value, and time consumed for the display transparency changing from 100% to the preset value is less than a maximum threshold; for the object on which an operation is accomplished, in a case that the idle duration after the operation is accomplished is greater than the maximum threshold, the object is closed or deleted, thus the number of objects on the display interface is decreased, and the display interface becomes more concise; further, during adjusting the display transparency of the display interface, if it is detected that an object is operated, the display status of the object is adjusted to a status in which display transparency is zero.

In addition, adjustment to the display status of an object according to the embodiment is not limited to adjusting display transparency, and it may be achieved through adjusting other status parameters such as background color. As long as a status parameter may lead to a change in status and may allow an operator to intuitively differentiate the objects in different operating status, which is not described herein.

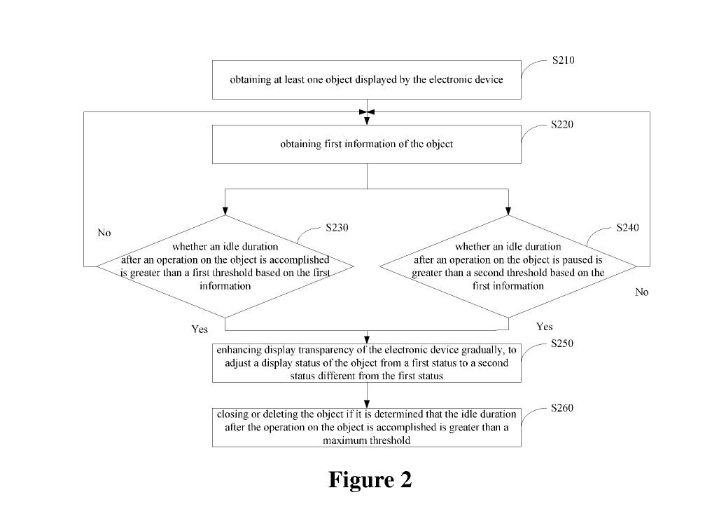

Based on the above analysis, a display control method is provided according to an embodiment of the disclosure, with a flowchart shown in FIG. 2. The method is applied to an electronic device, and may include steps S210-S260.

Step S210 may include obtaining at least one object displayed by the electronic device.

Step S220 may include obtaining first information of the object.

Step S230 may include determining whether an idle duration after an operation on the object is accomplished is greater than a first threshold based on the first information; if yes, the process proceeding to step S250; if no, the process returning to step S220.

Step S240 may include determining whether an idle duration after the operation on the object is paused is greater than a second threshold based on the first information; if yes, the process proceeding to step S250; if no, the process returning to step S220.

It should be noted that, there is no a sequence between step S230 and S240.

Step S250 may include enhancing display transparency of the electronic device gradually, to adjust a display status of the object from a first status to a second status different from the first status.

It may be seen that, the display transparency in the first status of the object is different from that in the second status of the object, which allows the user intuitively differentiate the objects in different operating statuses accordingly.

Step S260 may include closing or deleting the object if it is determined that the idle duration after the operation on the object is accomplished is greater than a maximum threshold.

In practice, the electronic device may include a plurality of timers, and once it is detected that an operation on the object is accomplished or paused, timing starts. In a case that the idle duration after the operation on the object is accomplished or paused is greater than the first threshold, step S250 is executed. In a case that the idle duration after the operation on the object is accomplished or paused is greater than the maximum threshold, the object is closed or deleted. With the technical solution, display interface of the electronic device may be concise, and manual operation for closing or deleting an object may be saved.

During step S250 to S260, once it is detected that an operation on the object is performed, the display status of the object is adjusted to a status in which display transparency is zero, i.e., a non-transparent status.

In conclusion, according to the embodiment, at least one object and first information of the object are obtained; and if it is determined an idle duration after an operation on the object is accomplished is greater than a first threshold, or an idle duration after an operation on the object is paused is greater than the second threshold, display transparency of the electronic device is gradually enhanced, to allow the display status of the object to be adjusted from a first status to a second status different from the first status, which allow the user to intuitively differentiate the objects in different operating statuses, thus the user experience is improved. If the idle duration after the operation on the object is accomplished is greater than a maximum threshold, the object is closed or deleted, which conveniently makes the display interface of the electronic device more concise without manual operation of the user.

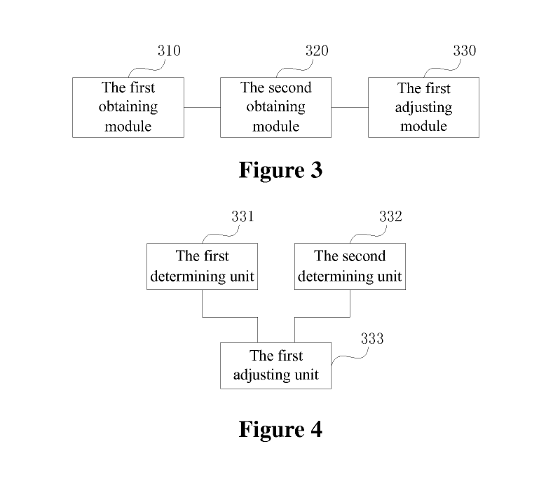

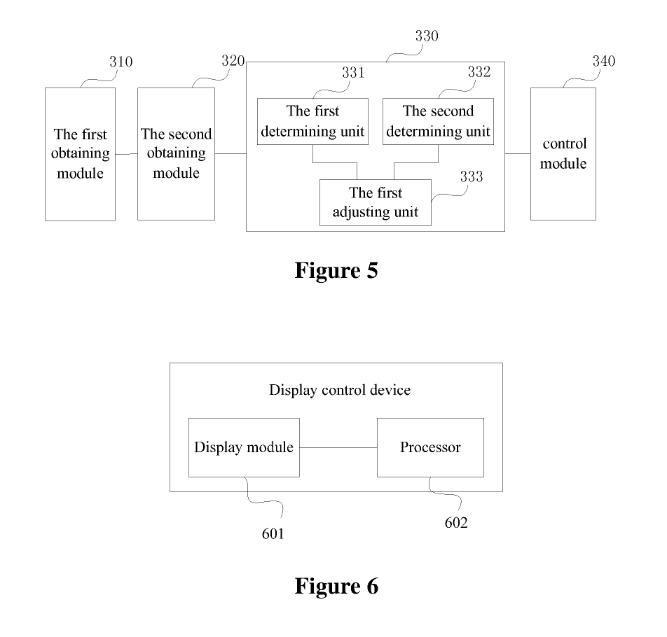

FIG. 3 is a structural diagram of a display control device according to an embodiment of the disclosure. The device may be applied to an electronic device, and may include a first obtaining module, a second obtaining module, and a first adjusting module.

The first obtaining module 310 is configured to obtain at least one object displayed by the electronic device.

The electronic device may be an electronic device with a display screen, such as tablet computer and cell phone, and the disclosure is not limited herein.

The second obtaining module 320 is configured to obtain first information of the object.

The first information may include a current operating status of the object, for example, an operation on the object being performed, an operation on the object is paused or accomplished, and an operation on the object is paused. And the first information may further include time when the object enters the current operating status, etc. The first information may be determined based on an actual situation, and are not enumerated herein.

The first adjusting module 330 is configured to adjust a display status of the object from a first status to a second status different from the first status, in a case that the first information meets a first predetermined condition.

In practice, if the first information of the object meets the first predetermined condition, the first adjusting module adjusts the display status of the object from the first status to the second status different from the first status, so that the current display status of respective objects to be different, allow the user to intuitively differentiate the respective objects which enhances the user experience significantly.

Optionally, FIG. 4 is a partial structural diagram of a display control device according to another embodiment of the disclosure. Based on the above embodiment, the first adjusting module 330 may include a first determining unit 331, a second determining unit 332, and a first adjusting unit 333.

The first determining unit 331 is configured to determine whether an idle duration after an operation on the object is accomplished is greater than a first threshold.

The second determining unit 332 is configured to determine whether an idle duration after an operation on the object is paused is greater than a second threshold.

The first adjusting unit 333 is configured to adjust the display status to the second status different from the first status, in a case that a determining result of the first determining unit or the second determining unit is yes.

In practice, the first adjusting unit 333 may adjust the display status of the object through adjusting display transparency of the object. Specifically the display transparency of the object may be enhanced with time, to adjust the display status of the object from the first status to the second status different from the first status.

In addition, based on above embodiments, the device may further include:
a control module 340, configured to close or delete the object, in a case that the idle duration after an the operation on the object is accomplished is greater than a maximum threshold.

It should be noted that, if an operation on the object is paused, the display transparency may be increased with time. When the display transparency reaches a preset value, the display transparency stops change. The control module does not close or delete the object on which an operation is paused, e.g., a paused music/video play window and an edit-paused textbox. In a case that the operation on the object in paused, object becomes more and more transparent with time, but is not closed or deleted.

As another embodiment of the disclosure based on above embodiments, the device may further include:
a second adjusting module, configured to adjust the display status of the object to a status in which display transparency is zero if it is detected that an operation on the object is performed.

It may be seen that, whatever operating status the object stays in, once it is detected that the object is operated, the display status of the object is adjusted to the status in which display transparency is zero, that is, non-transparent status.

According to an embodiment of the present application, it is provided another display control device, as shown in FIG. 6, the device includes: a display module 601 and a processor 602.

The display module 601 is configured to display at least one object.

The processor is configured to obtain the at least one object displayed by the display module 601, obtain the first information of the object, and adjust a display status of the object from a first status to a second status, in a case that the first information meets a first predetermined condition.

Optionally, the processor 602 is configured to determine whether an idle duration after an operation on the object is accomplished is greater than a first threshold, determine whether an idle duration after an operation on the object is paused is greater than a second threshold, and adjust the display status of the object from the first status to the second status, in a case that the idle duration after the operation on the object is accomplished is greater than the first threshold or the idle duration after the operation on the object is paused is greater than the second threshold.

Optionally, the processor 602 is configured to close or delete the object, in a case that the idle duration after an operation on the object is accomplished is greater than a maximum threshold.

Optionally, the processor 602 is configured to adjust the display status of the object to a status in which display transparency is zero in a case that it is detected that an operation on the object is performed.

If the object is being operated, display brightness of the object may be properly increased to make the object more obvious, so that the object may be differentiated from the object on which an operation is just accomplished or paused. The disclosure is not limited to this differentiation method, and whatever obtained by those skilled in the art without creative effort, falls within the protection scope of the disclosure.

It should be noted that, in the disclosure, relational terms such as the first and the second are only configured to distinguish a unit or operation from another unit or operation, and it does not necessarily require or imply that there are such actual relationships or sequences among the units or operations. Furthermore, the term ‘include’, ‘comprise’ or any other variant thereof intends to cover a non-exclusive inclusion, thus allows a process, a method, an object or an device including a series of elements to include not only the elements, but also other elements not clearly listed, or to include intrinsic elements of the process, method, object or device. In a case that there are no more restrictions, elements defined by the statement ‘include a . . . ’ do not exclude the case that other similar elements exist in the process, method, object or device including the elements.

Based on the forgoing description, those skilled in the art may be clear that, the disclosure may be implemented through combination of software and essential hardware platform, or all through hardware, and the former is the preferred implementation in many cases. In view of this, all or part of the technical solution of the disclosure contributing to the background technology may be embodied in a software product, and the computer software product including a number of instructions may be stored in a storage medium such as ROM/RAM, disk and compact disc, in order to allow a computer equipment (may be personal computer, server, or network equipment) to execute the method according to respective embodiments or some parts of the embodiment.

The respective embodiments of the disclosure are described in a progressive manner, each embodiment focuses on a difference from other embodiments, and for a same or similar part, the embodiments may refer to each other. The device embodiment corresponds to the method embodiment, thus description is brief, and for relevance, the method part may be referred to.

Principles and implementation of the disclosure are illustrated using examples, and the above description of embodiments is to help understand the method and core idea of the disclosure; various modifications made to the embodiments are apparent to those skilled in the art, and the general principles defined in the disclosure may be implemented in other embodiments without departing from the spirit and scope of the disclosure. Hence, the disclosure is not limited to the embodiments described in the disclosure, but conforms to a widest scope consistent with the principles and novel features in the disclosure.

What is claimed is:

1. A display control method, comprises:
obtaining at least one object displayed by an electronic device;
obtaining first information of the object;
determining whether the first information meets a first predetermined condition; and
adjusting a display status of the object from a first status to a second status, if it is determined that the first information meets the first predetermined condition.

2. The method according to claim 1, wherein the process of determining whether the first information meets a first predetermined condition comprises:
determining whether an idle duration after an operation to the object is accomplished is greater than a first threshold; and
determining that the first information meets the first predetermined condition if the idle duration after the operation on the object is accomplished is greater than the first threshold;
or,
determining whether an idle duration after an operation to the object is paused is greater than a second threshold; and
determining that the first information meets the first predetermined condition in a case that the idle duration after the operation on the object is paused is greater than the second threshold.

3. The method according to claim 1, wherein display transparency in the first status of the object is different from the display transparency in the second status.

4. The method according to claim 2, further comprising:
closing or deleting the object if it is determined that the idle duration after the operation on the object is accomplished is greater than a maximum threshold.

5. The method according to claim 1, further comprising:
adjusting the display status of the object to a status in which display transparency is zero, in a case that it is detected that an operation on the object is performed.

6. A display control device, comprising:
a display module, configured to display at least one object;
a processor, configured to obtain the at least one object displayed by the display module;
obtain first information of the object; and
adjust a display status of the object from a first status to a second status, in a case that the first information meets a first predetermined condition.

7. The device according to claim 6, wherein the processor is configured to:
determine whether an idle duration after an operation on the object is accomplished is greater than a first threshold;
to determine whether an idle duration after an operation on the object is paused is greater than a second threshold; and
adjust the display status of the object from the first status to the second status, in a case that the idle duration after the operation on the object is accomplished is greater than the first threshold or the idle duration after the operation on the object is paused is greater than the second threshold.

8. The device according to claim 7, wherein the processor is configured to:
close or delete the object, in a case that the idle duration after an operation on the object is accomplished is greater than a maximum threshold.

9. The device according to claim 6, wherein the processor is configured to:
adjust the display status of the object to a status in which display transparency is zero in a case that it is detected that an operation on the object is performed.
